(19) United States
(12) Patent Application Publication
(10) Pub. No.: US 2007/0276799 A1
(43) Pub. Date: Nov. 29, 2007

(54) Method And A Device For Addressing Data In A Wireless Network

(76) Inventors: Matti Kalervo, Helsinki (FI); Jyri P. Salomaa, Jorvas (FI); Hannu Flinck, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 10/572,700

(22) PCT Filed: Sep. 17, 2004
(86) PCT No.: PCT/FI04/00545

§ 371 Date: Jan. 10, 2007

(30) Foreign Application Priority Data
Sep. 18, 2003 (FI) 20031339

(51) Int. Cl. G06F 17/30

(52) U.S. Cl. 707/3

(57) ABSTRACT

A method and a device such as a modern mobile terminal for addressing reachability information over a wireless communications network providing access to a number of data elements. First, criteria are obtained for finding information related to at least a single person or entity (404), and then, a search is conducted in the wireless communications network or a connected network thereof in order to access data substantially fulfilling the criteria (406). Next, at least part of the data found is associated with a context (408), and finally the reachability information is established on the basis of the context (410).

### FIELD OF THE INVENTION

The present invention relates generally to communication systems. Particularly the invention concerns addressing and lining of data in wireless communications networks. The invention may be utilized for searching reachability information of people or other entities.

### BACKGROUND OF THE INVENTION

At the advent of modern telecommunications era a line telephone was invented by Alexander Graham Bell in 1876 and first taken into use by the authorities and larger communities such as villages and companies. Gradually the exploitation of this “long-distance conversation machine” spread into smaller and smaller groups of people, eventually concerning e.g. a single family or maybe just a single person. In any case, the basic regularity did not change; as the telephone lines were fixed, the people did not really benefit from carrying the phones with them even if the actual telephone apparatus got smaller and more elegant. Accordingly, the next huge step in personal communications was the development and adoption of mobile, in practise wireless, terminals that use the air instead of copper wires as a transfer medium to carry the signal between the user and either the access point to the fixed network or the other user in case of direct wireless terminal-to-terminal type transmissions, the latter being possible, for example, in walkie-talkie type radio phones or in the TETRA (Terrestrial Trunked Radio) system targeted for professional use.

Today's people are not tied up with a certain location, culture, surrounding people or social background so much anymore. All this results not least from the emergence of different modern telecommunication systems that are practically global and most importantly, free of location as being wireless. However, even the contemporary wireless systems carry some defects that clearly hinder the theoretically optimal use of the related terminals. One obvious problem relates to the limited range of radio frequency devices concerning especially mobile phones with reasonable power consumption. The network coverage in overall gets better all the time depending on the system at issue but there will still remain holes in it, e.g. due to nasty geographical obstacles on the radio path. Another, probably even more annoying, defect arises from the diversity of communication systems and services available at the moment. Of course, a number of different systems and services surely guarantee that there exists something useful for everyone but, on the other hand, varying systems and services seldom utilize exactly similar data addressing and linking technologies. For example, in the fixed land telephone network a string of digits represents the address of a single subscriber and thus works as an identifier thereof. On the Internet e-mail addresses are, being not the only possibility for addressing, anyhow the most widely adopted solution for delivering personal contact information, thanks to relatively easy readability. Correspondingly, in mobile networks, e.g. in the near-worldwide GSM (Global System for Mobile communications) system, a similar type of numeric addressing is utilized. What comes to the linking issues, situations occur wherein the name of the recipient is known but that as such does not help (enough) in solving the addressing means usable by the communication system in question without relying on external sources of information. When thinking about the common telephone network, the white and yellow pages do exist including the linkage between the subscriber name and the telephone number thereof. Likewise, there are services for solving an Internet address such as an e-mail account for given personal identification data. In addition, almost all services and modes of modern electric communication, including SIP (Session Initiation Protocol) and Bluetooth have the addressing means and addresses of their own.

A straightforward option for a person willing to contact another person is just to remember his personal contact information, the information being probably system/service specific; not an easy task when the total number of contacts grows to tens or even hundreds. Anyhow, in practise nobody is neither willing nor able to carry a book with personal data and addressing/linkage information with him. Furthermore, even if all the new technologies are exploited to some extent, which opens various different ways for communication, the original relations between people are still lost or, at least, not especially maintained by the systems in question. In other words, current addressing methods are not expressive enough to utilize additional associations of addressing information with time, place, group, mission, culture, social relationships etc. Still further, as new systems and service typically introduce addressing mechanisms of their own, linking people becomes harder and harder as a consequence, which basically is contrary to the original purpose of developing new methods of communication.

In addition to mere global electronic mail, referring to the e-mail communication. Internet has also brought new data addressing and linking model into common awareness. One of the reasons why the distributed network the Internet without doubt is at its best has proved to be so popular as is relies on the fact that varying types of data possibly located at different edges of the world can be easily available from a single location through a single interface due to the available common addressing/linking/data access mechanisms. For example, a URI (universal Resource Identifier) defines both the protocol and the location in the network for the target data. The Web browser may then be used as a common interface for accessing most if not all the data in the network. When different applications/services are designed with the aforesaid basic components in mind, the system may be expanded with ease to cover even more data spaces with complex linkage embedded within and between them.

### SUMMARY OF THE INVENTION

The object of the present invention is to provide a new method for addressing reachability information over a wireless communications network thus alleviating the aforesaid defects introduced by the prior art solutions. The object is achieved by utilizing a solution in which possibly distributed basic reachability information and associated auxiliary information such as calendar and location information is first retrieved from the wireless network and/or connected networks thereof. Based on this the most preferable addressing scheme and corresponding communication method are selected by further analysis. The target of communication, being e.g. a person, place, data or other entity, can be addressed by utilizing several different reachability means like E.164 telephone number, SIP URI, e-mail address, IP address, street address, or even more or less free-form description like “a small red cottage on a hill top near Vuosaari harbour” etc. The auxiliary information may help in selecting the most preferred technology for addressing in a case-specific manner.

Varying reachability and auxiliary information can be collected and associated with a meaningful context. The information as such can be maintained in the wireless network, in the terminal connected to the network, or in a connected external network like the Internet as distributed or gathered in the specific directory services. The reachability information related to the communication target such as a person or entity is created dynamically and bound to the end point address based on the context information. Several parties may create reachability information elements: the user himself, other users, authorities or end-user activities and devices (in an automated fashion), e.g. location registrations, sensors etc. Associations and grouping of the information are done automatically. The invention allows users to form user groups based on a variety of data (names, numbers, work relations, etc.).

The invention offers many advantages over prior art. Data under at least partly a common topic or carrying a common factor may be stored as distributed and data elements may comprise references to each other. A reference may, in addition to some well-known or “standardized” linking technology like a URI, be whatever combining factor such as a certain character string included in the elements. Then by utilizing these already existing, or by creating new, links or other references between people and personal data elements thereof the traditional addressing model (e.g. strictly centralized number allocation) of mobile networks is superseded. The basic ideas relating to contexts, link type addressing and reachability benefit from the distributed approach wherein the network, not e.g. a single terminal, preferably maintains the data that the end user may utilize and possibly edit by using his terminal device as an access and data processing tool. The distributed approach enables maximum versatility of the information available as a plurality of people may add, remove, update or otherwise cultivate it whenever necessary. In addition, the gathered or newly created data may be stored in the terminal as well if the user wants to keep some of the data private or just personalize his interface by the information without providing actually valuable information for other's use. The user may, for example, define some terminal-specific or identity specific (then the setting have to be stored e.g. in the SIM (Subscriber Identity Module) card or in the network) rules that specify the preferred way of accessing the personal identity, reachability or other data in his terminal. Accordingly, multiple sources of information provide reliability to the system as a whole as e.g. person-related data collections may be created on the basis of several data sources available.

Furthermore, the solution of the invention is flexible as the user may define the data he is willing to use for creating person or other entity related information. Still further, the solution provides “all in one” type solution, i.e. the user may select the information from a larger information space than he is willing to exploit at that moment or alternatively, use all available data without need to spend time in twiddling with a number of applications made for different purposes (traditional phone book, e-mail address directory, personal Web pages etc.) in order to access similar information. Yet, as there is no fixed addressing model (maybe a preferred one anyhow) the system will either completely automatically or in manual guidance by the user choose the model that suites best for the given constraints by combining different available address models and the prevailing context. The context may include data about time, place, purpose of the communication, application, terminal id, access policies, etc. The most convenient method and end point for the communication are selected.

As the proposed invention may take advantage of information delivered from a plurality of various sources it also enables creation of new type value chains. The traditional centralized model (around a single network operator/service provider, for example) with a fixed hierarchy is doomed to serve an average user only and is therefore not optimal for anyone in particular, although it may be relatively easy to use from the scratch. However, the versatility the method of the invention offers to the user after maybe a bit more complicated adoption stage cannot be reached with prior art models.

Considering the utility of the invention in real-life use cases by referring, for example, to the aforesaid global multi-cultural environment and current mobile systems' limited radio range, the invention can solve problems arising in a number of occasions. For example, the target entity of the communication, being e.g. a real person, is having his vacation in a foreign country and travelling on a bus at the specific time instant of information (relating to him) retrieval and analysis by another person, the information seeker. Now, if any location information connecting the target person to the country he is visiting in and to the bus he is travelling on is available to the information seeker, the analysis result may provide, with the help of predetermined “cultural rule” sets etc, a proper way of contacting the target person by taking the available location information into account. Depending on the country, it may or may not be socially appropriate to call a person travelling on a bus (or actually answer a call while travelling on a public service vehicle) etc and thus alternative contacting methods like SMS messages may be favoured. Likewise, if according to the retrieved information the target person is not available for real-time communication, e.g. his status is “not registered to the network”, the method of the invention may directly suggest using some non-realtime contacting method.

According to the invention, a method for addressing reachability information over a wireless communications network providing access to a number of data elements, is characterized in that it comprises the steps of
obtaining a number of criteria for finding information related to at least one person or entity,
executing a search in the wireless communications network or a connected network thereof in order to access data substantially fulfilling the criteria,
associating at least part of the data found with a context,
establishing the reachability information on the basis of the context.

In another aspect of the invention, an electronic device for addressing reachability information over a wireless communications network providing access to a number of data elements, said device being operable in said wireless communications network and comprising processing means and memory means for processing and storing instructions and data, is characterized in that it is arranged to obtain a number of criteria for finding information related to at least one person or entity, further arranged to execute a search in the wireless communications network or a connected network thereof in order to access data substantially fulfilling the criteria, arranged to associate at least part of the data found with a context, and finally arranged to establish the reachability information on the basis of the context.

The term “reachability information” is used in wide sense in the text. In practise, any identity or address data as described hereinbefore can be perceived as aforesaid information. In addition to just a single person, the reachability information may concern data or a group of people like an association, a sporting club, a company or even the covering entity as such without actually carrying a direct link to any real person and her data.

In an embodiment of the invention, Ed wants to access the contact information of the father of his son's tennis (club) mate. First, Ed types in the key words on his terminal's phone book interface modified in accordance with the invention: his son's name, Jason, with the tennis club's name. With the tennis club information the system can reach the member list of the club and from that list especially John, Jason's friend. Under John's name a link relating to his parents is found and finally also different ways to reach them.

In another embodiment of the invention, David wants to call Mary, who has written a report on Internet addressing. David then keys in Mary and the title or other reference of the report itself. A Web search is executed and related information is returned. The search returns Mary's contact information, calendar and supplementary schedule-related information. The system creates the context for Mary based on the calendar. It appears that Mary is attending a conference in Japan and due to time difference it is not appropriate to make a phone call, but the system ends up with recommending a SMS (Short Message Service) or e-mail connection instead. The basic Web search is now extended with supporting sorting rules for selecting the proper optional B-party and suitable means of communication. David primarily wants to reach just some one qualified party to answer about his urgent question about Mary's report, not necessarily Mary herself. As Mary is currently not available for real-time communication, the system provides an additional B-party Mike, who is also able to provide the needed answer, and the found reachability information of his.

Dependent claims disclose embodiments of the invention.

### BRIEF DESCRIPTION OF THE DRAWINGS

Hereinafter the invention is described in more detail by reference to the attached drawings, wherein

FIG. 1 discloses an overall concept of the invention.

FIG. 2 illustrates the first embodiment of the invention.

FIG. 3 illustrates the second embodiment of the invention.

FIG. 4 is a flow diagram disclosing one option for performing the proposed method of addressing personal information.

FIG. 5 is a flow diagram disclosing parts of FIG. 4 in more detail.

FIG. 6 is an exemplary block diagram of an electronic device like a mobile terminal capable of executing the method of the invention.

### DETAILED DESCRIPTION OF THE PREFERRED EMBODIMENTS OF THE INVENTION

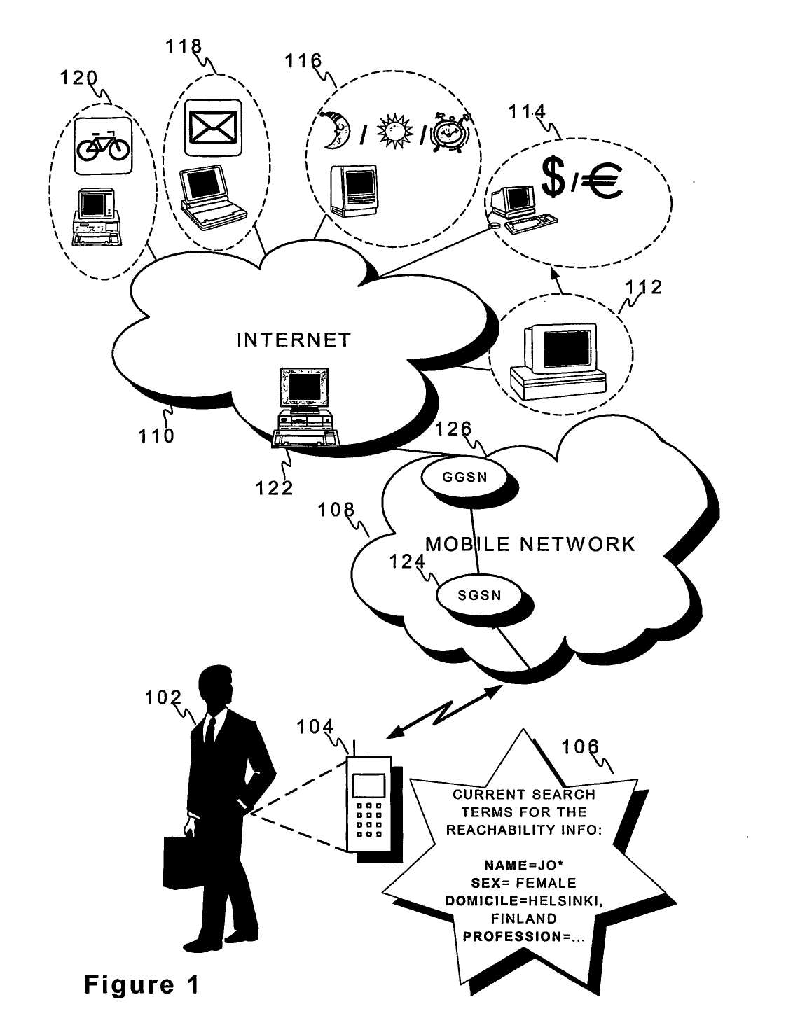

FIG. 1 discloses the overall concept of the invention by way of example. A person exploiting the invention 102 carries a modern mobile terminal 104 with him in order to call his contacts or access the data network such as the Internet 110 through the mobile communications network 108 anytime he wants. In the case of GPRS (General Packet Radio Service) network the user first registers his terminal to the SGSN 110 (Serving GPRS Support Node) by utilizing a GPRS attach procedure and then creates a PDP context (Packet Data Protocol) in order to access external datasources via the GGSN 112 (Gateway GPRS Support Node). Terminal 104 includes phone book and bookmark menus for addressing such data with ease, with no need to separately type in the addressing information for every single access. Sometimes, however, situations occur where either the preferred person or data entity does not belong to the regular “standard” set of contacts, thus the corresponding reachability information is not available in the terminal or at least the crucial missing detail is not there. Now, in the spirit of the invention, the person utilizes the modified user interface in his terminal, and especially the phone book thereof.

Person 102 keys in search terms 106 for conducting a data search first in terminal device 104 and then in mobile communications network 108 and connected networks 110 thereof in order to obtain the necessary reachability data he is after for. The query 106 is pre-processed in terminal 104 as terminal 104 itself may hold some valuable data related to the search terms; if terminal 104 comprises e.g. a cache memory for accessing the Web pages, the search may be conducted in those pages in addition to the standard phone book/personal record data including the phone numbers, e-mail addresses etc. If nothing is internally found, or in any case, search terms 106 are transmitted either as such or as modified with additional definitions to the communications network(s) 108, 110 (mobile network->Internet) for performing a further search. An entity conducting the actual search in the network side may be e.g. a search engine 112 addressed by the person himself (parameter in the setting etc.) or the default address and related device 122 whereto such search queries are always first led further controlling the search engine selection, for example, on the basis of the search term analysis (classification etc).

The search results can be analysed by network 108, 110 or by terminal 104 or by both; the aspect is more or less implementation specific. In any case, either the partially/fully/not at all evaluated result data is transferred to terminal 104 for the user's review. The more the network 108, 110 or the terminal 104 pre-processes the results, more easier it presumably is to person 102 triggered the search to find the information he was originally looking for. The retrieved data may, for example, be organized in a certain way, e.g. to the order of importance, estimated by the terminal/network device.

As mobile communications network 108 may be connected to a plurality of data sources like internal databases and preferably external data networks like Internet 110 or some private networks, the overall data space is immense and the search provides access to a lot more information than it would be sensible to e.g. permanently store in terminal 104. Moreover, as many different sources 112 (a search robot), 114 (context info), 116 (more context info), 118 (addresses), 120 (personal background info) may provide varying/supplementary information concerning partially common subject matter, many issues are covered more extensively as in a single service of a certain vendor. Of course, person 102 may have registered to some information services that are either subject to fee or private due to some other factor (club membership etc.); in those cases he may additionally define either in terminal 104 or on network side 108, 110 also these information sources to be included in the search. That way both the public and private data is available during a single search.

Moreover, if the data in the networks is mainly stored with support for commonly used Web/HTTP (HyperText Transfer Protocol) style data addressing/accessing means, a multiple standards or technologies are not needed for retrieving it and the overall flexibility of the arrangement rises to a next level. In the case of Internet 110 that's already reality and many private networks utilize the same techniques thus producing evident synergy effects.

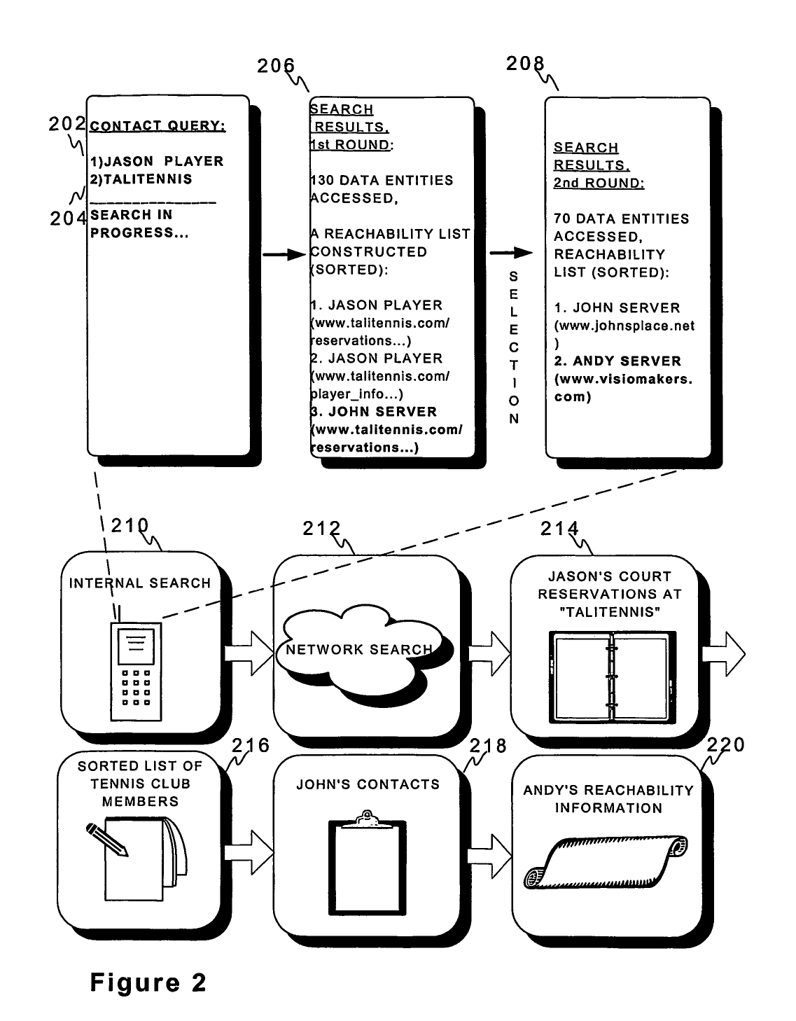

An actual first embodiment of the invention is first freely described with reference to FIG. 2 divided into two parts; the top part including few exemplary screenshots on a terminal display taken during the process and the lower one disclosing the corresponding high-level process steps.

Ed, the guy always on the move, wants to access the reachability information of the father of his son's tennis club friend. The problem relies on the fact that Ed doesn't actually know either the friend's or his father's true name. Thus, Ed activates the dynamic phone book functionality in his mobile terminal and types in the key words on his terminal's phone book interface modified according to the invention: his son's name “Jason Player” 202 with the associated tennis club's name “TaliTennis” 204. Next the terminal first accesses the internal memory in a local search for trails of any of the search terms 210. A standard entry in the phonebook is found including the phone number of Jason, his son, but as Ed knows, Jason is having his vacation abroad and is not able to take any phone calls to his mobile terminal due to an incompatible local radio access network. However, at this stage the search automatically continues as an external search 212 in a private mobile communications network and thereafter in a connected public data network such as the Internet. The continuation is automatic as the standard entry did not hold any information about the second key word “TaliTennis”. Ed has manually defined both a mobile and fixed (Internet, in this particular case) network servers that are first contacted for acquiring reachability information. The terminal has not a sophisticated search system/result analyzer embedded in this particular embodiment; the system on the network side traverses through the data and constructs the reachability data lists to be merely displayed on the terminal display. This time the mobile network search does not result any useful information in addition to Jason's mobile number that's already known but the Internet search system retrieves a link to “TaliTennis” WWW homepage that is automatically traversed through for acquiring further data. The system may provide intermediate information to the terminal about the query going on at this stage as well. “TaliTennis” has included a reservation system on their Web pages, which include recent court reservations and their current owners 214. Furthermore, the network site has a listing of the current tennis club members. The system analyses the calendar data and finds few reservations made by Jason with his playmates. The system sorts the tennis club members in relation to Jason 206, 216; persons who have made reservations with Jason are favoured over others.

Data is sent to the terminal for Ed's review. First two items listed relate in this case to Jason himself but the third one concerns “John Server”, the friend whose father Ed is actually willing to contact. Ed selects the John's name via the UI of his terminal and data about the selection is sent back to the network. Next the system searches for the information about John, this second query automatically starting from the just visited tennis club site. The system is tailored to search for a number of hints that typically predict existence of reachability information. These hints include e.g. numeric strings, e-mail addresses, tags normally associated with addressing info, phone numbers, and certain other manually definable strings usually attached to reachability data like “personal information”, “contact information”, “address”, “contact me” etc. In addition, the system may just provide the user a possibility to enter the Internet pages probably comprising reachability data so that the user can make conclusions of his own. Although not disclosed in the figure, Ed may also define the types/classes of the key words, “Jason Player” entered as a real person and “TaliTennis” as a related organisation, for example. Type definitions may be utilized in the search system to better track the person related data from all available data. Jason was the only name that was included in the original search as a person name (type/class definition) but the search system was programmed to distinguish other personal IDs by data locations; as reservation lists typically include personal identifiers, other field placed similarly to Jason's ID like “John's reservations” may be considered as those as well.

So, by using John's name as a key word the system locates other data within the tennis club domain carrying elements supposedly indicating reachability information. That is actually John's contact information 208, 218 stored in the tennis club's electric contact book including phone number, e-mail address, a link to his home page and subsequent links to his friends' and family members' Web pages. Pages behind the links are automatically analysed (a maximum depth for traversing attached data elements can be defined for saving system resources and time) and the results are transmitted to the terminal. Ed notices a link to a Web page that holds various contact data, for example, a phone number and e-mail address 220 of “Andy Server”, who is presumably John's father as the link is named “my father's consulting company” in John's link collection when Ed checks out the page leading to the company's contact page. Ed may now pick up and store the reachability information in order to contact Andy when wanted. It should be noted that it's advantageous to give the user a possibility to check out the source of the reachability information as well, maybe even the whole path from the initiation address of a search to the end point to ensure the correct navigation performed by the search system. This feature, as being quite straightforward to understand and implement, is not depicted in FIG. 2.

In another embodiment of the invention, a phone book of a mobile device is replaced with an interface to a search engine with embedded decision rule logic/parser and cache. The search application may optionally try to recognize the classes of the search terms in question in order to perform the search, for example, utilizing different information sources defined for different classes. Alternatively, the search terms may have been typed/classified by the user (like “Mary Thompson”=person, “Study on Internet addressing”=focus, or the entering order of the key words may be used to represent their classes as well etc.)

The user may define the preferred B-party with a number of search terms such as location, device, name, time, URI etc, and the device checks if an internal reference to any of the attributes entered is found. If that's the case and depending on the attribute type as some information ages faster than other (e.g. local time data vs. phone number), the related information may be exploitable and presentable to the user as such like phone numbers or e-mail addresses. In any case, however, it's advantageous to also conduct a new network search in order to update all the existing information and possibly receive new supplementary data. The returned results will be associated with a context created for the search terms. The context may be permanently stored and updated in the terminal to be used in connection with the next search relating to at least partially same target data. The context comprises data elements gathered from a number of sources during the search that are then linked together to form the context. In addition, the mobile device advantageously stores the resulting context data elements (in a separately accessible form) in the memory like cache with an optional expiry timer based on the usage activity to save memory in order to enable utilizing them when executing a new possibly different search.

A related use case is presented hereinafter. David knows that Mary has written an interesting study on Internet addressing. David launches a modified phone book application on his terminal and keys in the search terms: “Mary Thompson” and “Study on Internet addressing”. The phone book search application performs an internal search followed by an external search, and retrieves all the data found to be associated with the key words (˜search terms). As the search application is programmed to always check a few private contact info directories through in addition to a standard generic Web search, the retrieved data is at least partially well defined and thus easy to analyse for displaying purposes.

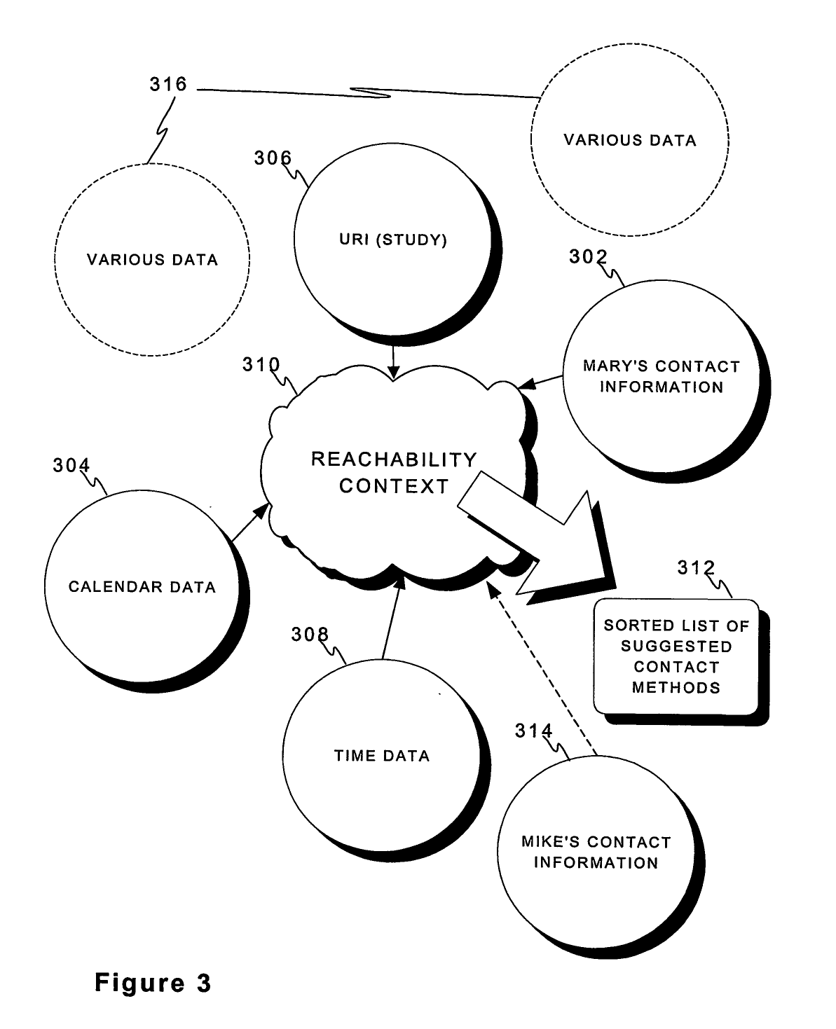

Referring to FIG. 3, the retrieved data includes Mary's line phone number, GSM number, SIP address, and e-mail address that may all be considered as contact information type data 302 being included in a single circle element in the figure for clarification purposes. URI 306 pointing to the study is received as well. If the target data element (study etc) is large in size, it's better to construct just a link for it before receiving an acknowledgement from the user to really download the file. Moreover, Mary's public calendar data 304 is received in a standardized form (like Outlook) from her homepage. Differing from the first embodiment, actual context 310 is now formed on the basis of retrieved information. The search engine application notices from the calendar data (by utilizing embedded data extraction logic from standardized calendar fields) that Mary is actually attending a conference in Japan, thus local time information 308 is automatically retrieved from a location specified in the search application preferences. Next the search application checks the local time and deduces that a voice call is not a recommended contact method due to the time difference; they are still in the small hours in Japan. Therefore the context data elements comprising different reachability means 312 are listed to David preferring more “silent” ways of communication: e-mail and SMS connections being the first, and a voice call as the last option.

Furthermore, the search engine/phone book application is enabled to create “secondary” reachability information based on the data found. In this particular example the Web page including the study also had a link to a home page of one of the co-authors, Mike. Thus the search engine also visited that link and retrieved his contact information directly found in a standardized from. However, as Mike was not included as a search term in the search, his contact information is listed last in the list. David may now construct a supplementary search in order to create a separate, complete context for Mike as well if willing to contact him instead of Mary, and contacting Mike would require more complete information before making the final decision who to contact and how.

FIG. 3 also discloses (dotted line) data elements 316 that are stored in the mobile device or in a connected external storage thereof but are not utilized during the creation of this particular context. Generally speaking, certain data elements can be exploited in a number of contexts. For example, if a sensor is providing data about who is present (utilizing Bluetooth scanning or whatsoever) at a certain location, the stored location data element comprising that info (although probably outdating fast but can be updated) may be utilized in a number of contexts made for a number of different search term combinations. In the visualized use case, dotted line data elements 316, although already stored and available for the mobile device's exploitation, are not useful in creating the context, i.e. no link was found between them and the search terms.

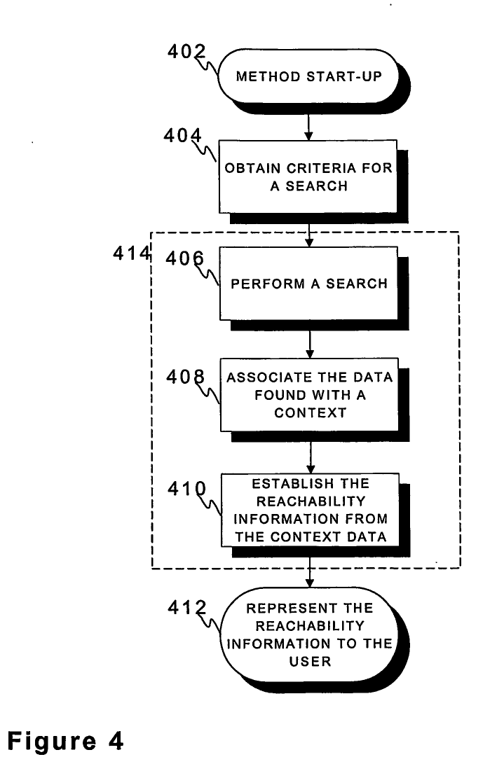

FIG. 4 discloses a generic flow diagram of the preferred method for addressing reachability information over a wireless communications network. The method pieces together the basic ideas presented in the previous embodiments. At method start-up 402, the user activates the search engine of the invention in his terminal device. In step 404 the search criteria (search terms, utilized information sources etc) are defined for finding information related to the target person or entity. The actual search is conducted in phase 406. The information found is first analysed by the device (or by an external analyser like a server in the network) by utilizing fixed and/or user defined parsing rules for extracting the data elements seen purposeful. The context is then created 408 on the basis of the selected data elements. Finally the reachability information is established 410 from the context data. The reachability information may be sorted according to predefined or dynamic criteria and shown to the user on the display of the device 412.

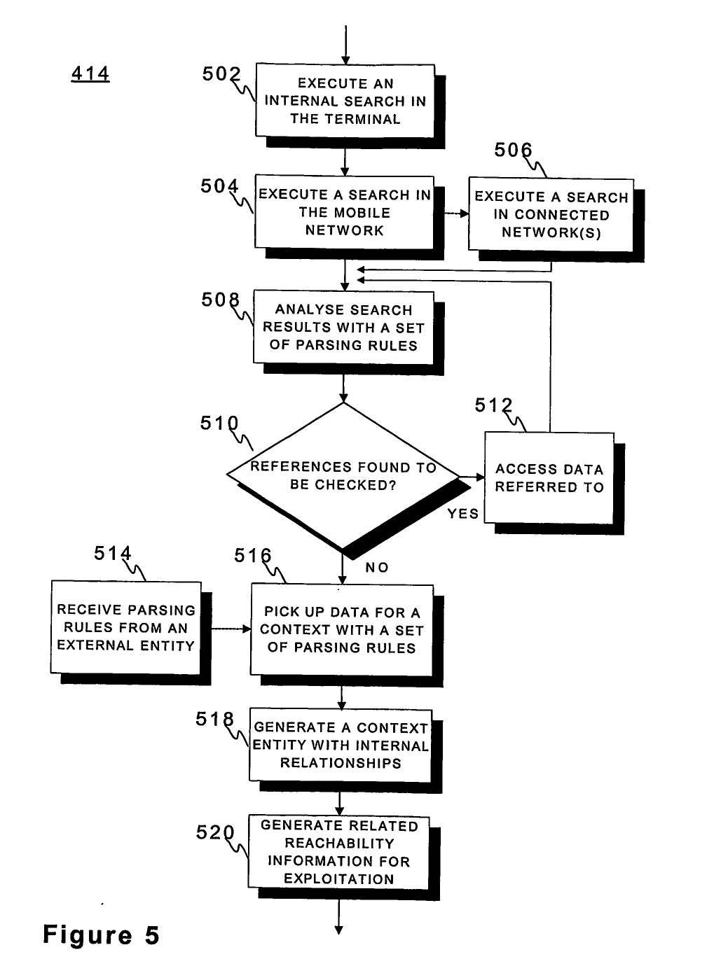

FIG. 5 discloses a more detailed flow diagram of blocks framed with dotted line 414. The solution described hereinafter is an example though, and many alternative options surely exist for carrying out the procedures presented. The search is first executed as an internal search 502 in the terminal, then continued in the mobile network 504, and finally performed in connected external networks 506 like the Internet if available, or just in some of aforesaid possibilities. The user may manually define the information sources for all the searches, or the search term classes may control the selection of the search space. From a technical perspective, the search may be conducted as in common Internet search engines or by even partially utilizing them. In step 508 the search results are analysed with parsing rules meaning relevant data is marked and found references 510 like URI links are followed into some (e.g. predefined) extent 512 in order to locate further relevant data for analysis. The context data is selected 516 with parsing rules (now more complex and detailed) by picking up relevant data elements from the overall gathered data space. The parsing rules 508, 516 can also be received from external sources and stored as data elements relating to certain context(s). For example, the rules may be impacted by target of the search: a cell phone with a scheduler may send a message as a response to the search request informed by a network entity (server, terminal device) and provide a new set of rules. An actual context entity is created in phase 518. The context entity may be implemented as a collection of references to data elements with preferred additional information. Reachability information is a cultivated presentation of the corresponding context's internals; the most preferable means of communication are selected from the context data. As disclosed in the second embodiment, e.g. calendar and time data elements may be used for sorting and evaluating the available reachability information.

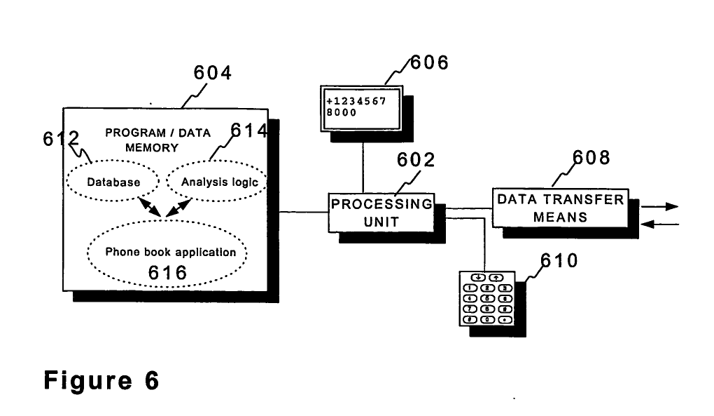

FIG. 6 depicts one option for basic components of a device like a modified modern mobile terminal capable of executing the method of the invention either completely by itself or by co-operation with a network entity such as a server/external search engine. The program code for the execution of the proposed method can be delivered on a carrier medium like a floppy, a CD or a memory card. The terminal may be e.g. a GSM or a UMTS (Universal Mobile Telecommunications System) terminal. A processing unit 602 is required for the actual execution of the instructions carrying out the method steps and for the overall control of the device. Program/data memory 604 (physically a memory chip or a memory card) comprises database 612 including the data elements retrieved through searches, thus forming the basis for the contexts. Analysis logic 614 includes a configurable rule set for the parser(s) that analyses data and creates the context from the returned search results, and a set of policies to select the most preferable means of communication based on the context Another necessity, modified phone book application 616, includes an interface such as a Web browser for the actual search engine that may be included in the terminal or in the mobile/connected network. A display 606 and a user interface like a keypad 610 are needed for providing necessary device control and data visualization means to the user. Data transfer means 608, e.g. a radio transceiver or a network adapter, are required for handling data exchange with the network and other devices.

The scope of the invention can be found in the following claims. However, utilized devices, method steps, data structures etc may vary significantly depending on the current scenario, still converging to the basic ideas of this invention. For example, it is clear that data elements constituting the contexts can be of a various nature, not exactly the ones presented hereinbefore. The method of the invention may also be utilized by a terminal not carrying all the necessary code to the execute the method as such; the terminal may access a server that takes care many or most of the tasks and delivers more or less print-ready data to the terminal for review.

1. A method communications network providing access to a number of data elements, characterized in that it comprising:
obtaining a number of criteria for finding information related to at least one person or entity,
executing a search in a wireless communications network or a connected network thereof in order to access data substantially fulfilling the criteria,
associating at least part of the data found with a context, and
establishing a reachability information on the basis of the context.

2. The method of claim 1, comprising data elements, wherein at least part of the data elements are stored in a distributed manner, said elements including references between them.

3. The method of claim 1, further comprising the step of executing an internal search in a device executing the method.

4. The method of claim 1, further comprising the step of visualizing the reachability information on a display of a device used for accessing the network.

5. The method of claim 1, wherein said obtaining is performed by setting the criteria with a device used for accessing the wireless network.

6. The method of claim 1, wherein said criteria are utilized as search terms for a phone book of a device used for accessing the wireless network.

7. The method of claim 1, wherein during the search a first set of data found is automatically traversed through and at least one associated reference followed in order to find a second set of data.

8. The method of claim 1, wherein said reachability information is sorted on the basis of the context data.

9. The method of claim 1, wherein the connected network is the Internet.

10. The method of claim 1, wherein said associating includes analysis and selection of certain data elements from all found elements.

11. The method of claim 1, wherein said associating or establishing is executed by utilizing a predefined rule set.

12. The method of claim 1, wherein rules for associating or establishing are received from an external entity.

13. The method of claim 2, wherein said references are substantially in a URI (Uniform Resource Identifier) form.

14. A computer program product including the program code stored in a readable medium such that when executed by a processor executes the method steps of claim 1.

15. A carrier medium carrying the computer executable program of claim 14.

16. An electronic device for addressing reachability information over a wireless communications network providing access to a number of data elements, said device being operable in said wireless communications network and comprising a processor and a memory respectively configured to process and store instructions and data, said device arranged to obtain a number of criteria for finding information related to at least one person or entity, further arranged to execute a search in the wireless communications network or a connected network thereof in order to access data substantially fulfilling the criteria, arranged to associate at least part of the data found with a context, and arranged to establish the reachability information on the basis of the context.

17. The device of claim 16, wherein at least part of the data elements are stored in a distributed manner, said elements including references between them.

18. The device of claim 16, wherein the device further comprises at least one of the following: a Web browser, a search engine, and parser in order to execute said search or perform said associating.

19. The device of claim 18, wherein the device further comprises a configurable rule set for a parser that analyses and creates the context from the returned search results.

20. The device of claim 16, wherein the device further comprises a set of policies to select the most preferable means of communication based on the context.

21. The device of claim 18, wherein the device is arranged to receive rules for a parser from an external entity.

22. The device of claim 16-21, wherein the device is substantially a GSM (Global System for Mobile Communications) or UMTS (Universal Mobile Telecommunication System) terminal.

23. A device comprising:
means for obtaining a number of criteria for finding information related to at least one person or entity,
means for executing a search in a wireless communications network or a connected network thereof in order to access data substantially fulfilling the criteria,
means for associating at least part of the data found with a context, and
means for establishing a reachability information on the basis of the context.
